(19) United States
(12) Patent Application Publication
(10) Pub. No.: US 2014/0280008 A1
(43) Pub. Date: Sep. 18, 2014

(54) Axiomatic Approach for Entity Attribution in Unstructured Data

(71) Applicant: INTERNATIONAL BUSINESS MACHINES CORPORATION, Armonk, NY (US)

(72) Inventors: Michael K. Boudreau, Orange, CA (US); Bradley T. Moore, Dana Point, CA (US); Ahmed Mousaad, Cairo (EG); Craig M. Trim, Sylmar, CA (US)

(73) Assignee: INTERNATIONAL BUSINESS MACHINES CORPORATION, Armonk, NY (US)

(21) Appl. No.: 13/833,899

(22) Filed: Mar. 15, 2013

(51) Int. Cl. G06F 17/30

(52) U.S. Cl. CPC G06F 17/30734
USPC 707/708

(57) ABSTRACT

The present specification relates to Ontology modeling, and, more specifically, to systems and methods for populating a triple store (RDF Graph) data structure from a parse tree diagram and producing a measurable increased degree of confidence in the reliability of the inferences based on the matched axioms derived from the ontology model. The steps of populating and producing can be performed automatically.

### BACKGROUND

The present specification relates to Ontology modeling, and, more specifically, to systems and methods for demonstrating how a triple store can be populated from a parse tree with the ability to show transitive actions (predicates) that have certain entities (subjects) are capable of committing on other entities (objects) within a particular degree of confidence.

Parse trees should be understood by those of ordinary skill in the art, and can be defined as a sentence that is annotated with a syntactic tree-shaped structure. There are existing conventional solutions that are capable of creating parse trees (aka “Treebanks”) from unstructured data as well as extracting triples from unstructured data. The NELL Knowledge Base browser, as should be understood by those of skill in the art, is an example of a solution that can extract facts (or “axioms”) from unstructured data. The existing conventional solutions, however, do not demonstrate how a predicate can be applied to other entities, within a given degree of confidence.

Accordingly, there is a continued need for a method and system for demonstrating how a predicate can be applied to other entities, within a given degree of confidence, including the high-value of such an approach in big data/unstructured data scenarios.

### SUMMARY OF THE INVENTION

Embodiments of the present invention comprise systems and methods for an axiomatic approach for entity attribution in unstructured data. According to one embodiment, a method comprises the steps of: (i) parsing, by a processor, unstructured source data; (ii) generating, by the processor, a first parse tree from the parsed unstructured source data; (iii) constructing, by the processor, an ontology model based on the first parse tree; (iv) augmenting, by the processor, the ontology model with data from an external ontology model augmentation source; (v) establishing, by the processor, instance data based on the augmented ontology model; (vi) establishing, by the processor, a first axiom from the augmented ontology model; (vii) expanding, by the processor, the first axiom into a plurality of axioms, each of which is a variation of the first axiom and is part of the instance data; and (viii) associating, by the processor, a confidence level to each of the first axiom and the plurality of axioms with variations.

In another implementation, a system comprises: (i) a parsing module programmed to parse unstructured source data; (ii) a generation module connected to the parsing module and programmed to generate a first parse tree from the parsed unstructured source data; (iii) a model ontology module connected to the generation module and programmed to construct an ontology model based on the first parse tree, wherein the model ontology module comprises an input configured to receive data from an external ontology model augmentation source and is programmed to augment the ontology model with the data from the external ontology model augmentation source; (iv) a model axioms module connected to the model ontology module and programmed to establish instance data based on the augmented ontology model, to establish a first axiom from the augmented ontology model, and to expand the first axiom into a plurality of axioms, each of which is a variation of the first axiom and is part of the instance data; and (v) an axiom confidence level establishment module connected to the model axioms module and programmed to associate a confidence level to each of the first axiom and the plurality of axioms with variations.

The details of one or more embodiments are described below and in the accompanying drawings. Other objects and advantages of the present invention will in part be obvious, and in part appear hereinafter.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic representation of a method and system for an axiomatic approach for entity attribution in unstructured data according to one embodiment;

FIG. 2 is a schematic representation of an Ontology model according to one embodiment;

FIG. 3 is a schematic representation of an Ontology model according to one embodiment; and

FIG. 4 is a schematic representation of a method and system for an axiomatic approach for entity attribution in unstructured data according to one embodiment.

### DETAILED DESCRIPTION

As will be described further herein, through the use of Natural Language Processing (NLP), Ontology modeling and Triple stores (RDF graphs), one embodiment demonstrates one or more of the following: (1) how NLP annotations lead to automated construction (or refinement) of an Ontology model; (2) the use of external sources to supplement the Ontology model; (3) the derivation of basic axioms from the Ontology model; (4) a method for expanding each of the axioms into multiple axioms with either wider or narrower semantic application; (5) association of a confidence level to the original axiom (step 3) and each expanded axiom (step 4); (6) provisioning the NLP engine with the axiom data (from step 5); and (7) repeat Step 1, with the benefit of new axiom data.

As used herein, “Natural Language Processing (NLP)” is the semantic and syntactic annotation (tagging) of data, typically unstructured text. Syntactic annotation is based on grammatical parts-of-speech and clause structuring. An example of syntactic tagging might be: The/determiner quick/adjective brown/adjective fox/noun. Semantic annotation is based on dictionaries that contain data relevant to the domain being parsed. An example of syntactic tagging might be: The quick brown fox/mammal. Annotation (tagging) is a form of discovery. Tags are essentially a form of meta-data associated with unstructured text. An ultimate purpose of tagging is the formulation of structure (intelligence for text mining and analytics) within unstructured data.

“Resource Description Framework (RDF)” is a meta-data model that allows information to be expressed in triple format (subject-predicate-object). RDF data are typically stored in triple stores. An example of a triple would be: fox/subject->jumpsOver/predicate->dog/object. Data in a triple store typically conforms to an Ontology model.

“Axioms” and “confidence levels” are concepts widely accepted on their own merits. An axiom may be used to describe a triple stored in an RDF graph, where the triple is used to make an assertion about a connection that does exist, or might exist. If the level of certainty is less than 100%, a confidence level is typically associated with the triple (in the form of reified triple) within the confidence level. Example: (Shakespeare wrote Hamlet) hasConfidenceLevel 100. (Hamlet writtenIn 1876) hasConfidenceLevel 20. Confidence levels may be derived based on the source of data or other means, or be manually assigned.

The process described according to this embodiment is iterative. As the process nears completion at step 7, the NLP engine has a more intelligent (expanded) knowledge base to draw upon. The next iteration of Steps 1-7 will result in the derivation of additional information. By looping through the process, this leads to the ability to: (1) Annotate (discover) full or partial axioms latent in the source data; (2) Infer additional information about the source data contained within the boundaries of the tagged axioms; and (3) Attribute the confidence level of the axiom to the inferred information. The model describing this process is discussed further below with reference to certain Figures.

Advantages of the invention are illustrated by the Examples set forth herein. However, the particular conditions and details are to be interpreted to apply broadly in the art and should not be construed to unduly restrict or limit the invention in any way.

A module, as discussed herein, can include, among other things, the identification of specific functionality represented by specific computer software code of a software program. A software program may contain code representing one or more modules, and the code representing a particular module can be represented by consecutive or non-consecutive lines of code.

Referring now to the drawings, wherein like reference numerals refer to like parts throughout, there is seen in FIG. 1 a schematic representation of a method and system for an axiomatic approach for entity attribution in unstructured data according to one embodiment. A process or set of processes is initiated in a real computing environment 100. Two main flow subsections are shown—150 and 160. Among other possible components, the main flow subsection 150 can include a parsing module 110, an annotations module 120, an execution module 130, and a generation module 140.

The main flow subsection 150 shows the flow of data starting with unstructured source data being inputted into the parsing module 110, and data exiting the generation module 140 as parse tree(s) 170. This data can flow from the parsing module 110 to the generation module 140 in a direct manner (flow from the parsing module 110 directly to the generation module 140) or in an indirect manner (flow from the parsing module 110 to the annotation module 120 to the execution module 130 and then to the generation module 140), depending on the answer to whether the Triple Store is provisioned at 103. If the answer is “yes,” the flow of the data is in an indirect manner. If the answer is “no,” the flow of the data is in a direct manner.

The parsing module 110 is structured, connected, and or programmed to parse unstructured source data input per arrow 101 into the parsing module 110. This initial parsing steps can consist of tokenization (as should be understood by those skilled in the art—breaking up sentences/text/phrases into “tokens” (smaller phrases and/or words), and these tokens are used as input for further processing herein) and other preprocessing. If the answer to whether the Triple Store is provisioned at 103 is yes, the unstructured source data that has been parsed by the parsing module 110 is input per arrow 105 to the annotation module 120 which is structured, connected, and or programmed to annotate recognized (partial) axioms. A partial axiom would be something discovered without further context. For example, if you encounter dog, it might be lazy, might be yellow . . . . It is preferable that the triple store 103 should be created once before it is populated. Population can happen at multiple points in time (ongoing, iterative); provisioning only happens once. The ontology or ontologies are loaded into the triple store. The output data from the annotation module 120 is input per arrow 107 into the execution module 130 which is structured, connected, and or programmed to execute the creation of a parse tree. The output data from the execution module 130 is input per arrow 109/113 into the generation module 140 which is structured, connected, and or programmed to generate parse trees 170.

Alternatively, if the answer to whether the Triple Store is provisioned is no, the unstructured source data that has been parsed by the parsing module 110 is input per arrow 115/113 to the generation module 140 which is structured, connected, and or programmed to generate parse trees 170, as described above.

An Example of the performance of the main flow subsection 150, from the parsing of unstructured source data to the generation of parse trees, is provided below.

Given the input text string “The quick brown fox jumped over the lazy yellow dog”, the output from the process set forth in the main flow subsection 150 of FIG. 1 would look like this:

<results>

<node prob=“−2.9092” span=“The quick brown fox jumped over the

lazy yellow dog.” type=“TOP”>

<node prob=“0.9997” span=“The quick brown fox jumped over

the lazy yellow dog.” type=“8”>

<node label=“S-S” prob=“1.0” span=“The quick brown

fox” type=“HP”>

<node prob=“0.9671” span=“The” type=“DT”/>
<node prob=“0.9567” span=“quick” type=“JJ”/>
<node prob=“0.0946” span=“brown” type=“JJ”/>
<node prob=“0.9665” span=“fox” type=“NN”/>

</node>
</node label=“C-Z” prob=“0.9996” span=“jumped over the

lazy yellow” type=“VP”>

<node label=“S-VP” prob=“0.5950” span=“jumped”

type=“U&D”/>

<node label=“C-VP” prob=“0.5595” span=“over the

lazy yellow= type=“PP”>

</node label=“S-PF” prob=“0.9991” span=“over”

type=“IO”/>

</node label=“C-PF” prob=“1.0” span=“the lazy

yellow=“ type=“UP”>

<node probe=“0.9790” span=“the”
type=“DT”/>
<node probe=“0.9686” span=“lazy”
type=“JJ”/>
<node probe=“0.6987” span=“yellow”
type=“MM”/>

</node>

</node>

</node>
</node prob=“0.5235” span=“dog.” type=“.”/>

</node>

</node>

</results>

Syntactic Part-of-Speech (POS) tags are highlighted as underlined (The Penn Treebank Tag standard, as shown be understood by those of skill in the art, was used here. However, the present embodiment is not limited to this standard.). The completion of this parse tree 170 is the output from the activity “Generate Parse Trees” by the generation module 140, and the input to the activity “Model Ontology” at the model ontology module 125 (i.e., NLP annotations lead to automated construction (or refinement) of an Ontology model, listed above). An Ontology can be constructed that has classes corresponding to nodes with POS tags of NN (Nouns). This would result in an Ontology model for the above sentence as shown in FIG. 2, where (1) Dog rdfs:subClassOf Thing, and (2) Fox rdfs:subClassOf Thing.

Also shown in FIG. 1 is main flow subsection 160. The activity shown by this main flow subsection 160 is a technique by which the model ontology can be augmented with information from outside sources (i.e., the use of external sources to supplement the Ontology model, as listed above). For example, by WordNet, as should be understood by those of skill in the art. However, the present embodiment is not limited to any single source for model augmentation.

The main flow subsection 160 shows model ontology module 125 being augmented with information from outside sources (here, WordNet, as described herein). This main flow subsection also shows model the model axioms module 135, triple store (RDF) database 175, Ontology 165, axiom confidence level establishment module 145, and NLP engine 155, and output from 155 can be used as input into the parsing module 110.

As shown in FIG. 4, a schematic representation of a method and system for an axiomatic approach for entity attribution in unstructured data according to one embodiment is shown. A sub flow process 400 related to FIG. 1 is shown. Input 419 can be input into model ontology class structure module 410 (via 401) and/or into model ontology predicate structure 430 (via 403). Output 405 from the model ontology class structure module 410 can be input (via 405) into the class refinement (with hyponyms) module 420 and output at 409. Output 407 from the predicate structure module 430 can be input into the predicate refinement (with troponymes) module 440 and output at 411. WordNet 185 can be input at 415 into the class refinement (with hyponyms) module 420, and can be input at 417 into the predicate refinement module 440.

An example of the performance of the main flow subsection 160 of FIG. 1 and the sub flow process 400 of FIG. 4 is provided below, which continues the Example discussed above with respect to main flow subsection 150 of FIG. 1.

Through the use of hypernymous relationships contained within WordNet (or another source), the Ontology model shown in FIG. 2 can be refined to the model shown in FIG. 3 (see also FIG. 4, and the class structure module 410, the class refinement (with hypernymes) module 420 and the WordNet input 185/415 to the class refinement module 420). For the sake of brevity, only a minor hierarchy is shown from Fox to Thing by way of Mammal. However a more complete hierarchy (Fox->Carnivore->Mammal->Animal->Organism->Thing) can and would typically be used. These hypernymous constructs are available within WordNet.

The use of Verb Phrases (VP) to establish predicates within the Ontology model will now be described (see also FIG. 4, and the predicate structure module 430, the predicate refinement (with troponymes) module 440, and the WordNet input 185/415 to the predicate refinement module 440). The predicate “jump” can be expanded via troponymous relationships from a source such as WordNet, in a manner similar to the hierarchy established for the noun entities above. In addition, for the predicate “jumpOver” (or “jumped”), a troponymous hierarchy can be established—jump is a kind of movement is a kind of action: jump rdfs:subPropertyOf movement rdfs:subPropertyOf action. In addition, synonyms from WordNet (or other sources) can be used to indicate this predicate can still be applied to occurrences of leaping, springing, bounding, etc found within the source text.

The use of Noun Phrase (NP) analysis will now be described. Through NP analysis, instance data for the Ontology model can be populated into the Triple Store (RDF graph) (see also FIG. 1, and the model axioms module 135, triple store (RDF) database 175, and axiom confidence level establishment module 145). Instance data that corresponds to class Fox would be {quick brown fox, quick fox, brown fox}.

quick brown fox rdf:type Fox
brown fox rdf:type Fox
quick fox rdf:type Fox

Instance data that corresponds to class Dog would be {lazy yellow dog, lazy dog, yellow dog}

lazy yellow dog rdf:type Dog
lazy dog rdf:type Dog
yellow dog rdf:type Dog

Via the Ontology model, the following axiom has been established: performAction:jumpOver(quick brown fox, lazy yellow dog).

Because this can occur, this axiom can be extended into the following axioms:

performAction:jumpOver(fox, dog)
performAction:jumpOver(quick fox, dog)
performAction:jumpOver(brown fox, dog)
performAction:jumpOver(quick brown fox, dog)
performAction:jumpOver(fox, lazy dog)
performAction:jumpOver(fox, lazy yellow dog)
etc.

Each variation is matched up against another variation, where all variations are part of the instance data. Note complete confidence can only be in the first axiom, since it was from this that the first axiom set was established. The original axiom will have a confidence level assigned to it within the triple store:

(quick brown fox performAction:jumpOver lazy yellow dog)

hasConfidenceLevel 100%

These axioms in turn become helpful for NLP engine 155. If the unstructured text “fox leaps over dog” is found, we now have a knowledge base that informs us that “leap” is a troponym for jumped. This allows us to match the axiom:

(peformAction:jumpOver(fox, dog)) hasConfidenceLevel<100%

Because the axiom match is less than 100%, attributes can begin to be inferred about the dog and the fox with a probability based on the delta between the matched axiom and any related axiom. This allows for the inference that the fox could be quick and brown (with a given degree of confidence) and the dog may be lazy and yellow (with a degree of confidence).

As will be appreciated by one skilled in the art, aspects of the present invention may be embodied/implemented as a computer system, method or computer program product. The computer program product can have a computer processor or neural network, for example, that carries out the instructions of a computer program. Accordingly, aspects of the present invention may take the form of an entirely hardware embodiment, an entirely software embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction performance system, apparatus, or device.

The program code may perform entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowcharts/block diagrams in the Figures illustrate the architecture, functionality, and operation of possible implementations of systems, methods, and computer program products according to various embodiments of the present invention. In this regard, each block in the flowcharts/block diagrams may represent a module, segment, or portion of code, which comprises instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although the present invention has been described in connection with a preferred embodiment, it should be understood that modifications, alterations, and additions can be made to the invention without departing from the scope of the invention as defined by the claims.

What is claimed is:

1. A computer implemented method for associating a confidence level to axioms derived from an augmented ontology model, the method comprising:
parsing, by a processor, unstructured source data;
generating, by said processor, a first parse tree from the parsed unstructured source data;
constructing, by said processor, an ontology model based on the first parse tree;
augmenting, by said processor, the ontology model with data from an external ontology model augmentation source;
establishing, by said processor, instance data based on the augmented ontology model;
establishing, by said processor, a first axiom from the augmented ontology model;
expanding, by said processor, the first axiom into a plurality of axioms, each of which is a variation of the first axiom and is part of the instance data;
associating, by said processor, a confidence level to each of the first axiom and the plurality of axioms with variations.

2. The method of claim 1, further comprising the step of annotating, by the processor, partial axioms within the parsed unstructured source data.

3. The method of claim 1, wherein the step of associating, by said processor, a confidence level to each of the first axiom and the plurality of axioms with variations further comprises creating a database of axiom data comprising the first axiom and the plurality of axioms with variations and associated confidence levels.

4. The method of claim 3, further comprises matching one of the first axiom and the plurality of axioms with variations with unstructured text within the unstructured source data, and inferring attributes about the unstructured text with a particular confidence level.

5. The method of claim 1, wherein the external ontology model augmentation source is a lexical database.

6. The method of claim 5, wherein the step of augmenting, by said processor, the ontology model with data from the external ontology model augmentation source further comprises the step of augmenting, by said processor, the ontology model with hyponyms obtained from the lexical database.

7. The method of claim 5, wherein the step of augmenting, by said processor, the ontology model with data from the external ontology model augmentation source further comprises the step of augmenting, by said processor, the ontology model with troponymes obtained from the lexical database.

8. A system for associating a confidence level to axioms derived from an augmented ontology model comprising:
a parsing module programmed to parse unstructured source data;
a generation module connected to said parsing module and programmed to generate a first parse tree from the parsed unstructured source data;
a model ontology module connected to the generation module and programmed to construct an ontology model based on the first parse tree, wherein said model ontology module comprises an input configured to receive data from an external ontology model augmentation source and is programmed to augment the ontology model with the data from the external ontology model augmentation source;
a model axioms module connected to said model ontology module and programmed to establish instance data based on the augmented ontology model, to establish a first axiom from the augmented ontology model, and to expand the first axiom into a plurality of axioms, each of which is a variation of the first axiom and is part of the instance data; and
an axiom confidence level establishment module connected to said model axioms module and programmed to associate a confidence level to each of the first axiom and the plurality of axioms with variations.

9. The system of claim 8, further comprising an annotation module programmed to annotate partial axioms within the parsed unstructured source data.

10. The method of claim 1, further comprising a database of axiom data connected to said axiom confidence level establishment module comprising the first axiom and the plurality of axioms with variations and associated confidence levels.

11. The method of claim 3, further comprising an NLP engine configured to match one of the first axiom and the plurality of axioms with variations with unstructured text within the unstructured source data, and to infer attributes about the unstructured text with a particular confidence level.

12. The method of claim 8, wherein the external ontology model augmentation source is a lexical database.

13. The method of claim 12, wherein said model ontology module step is further programmed to augment the ontology model with hyponyms obtained from the lexical database.

14. The method of claim 12, wherein said model ontology module step is further programmed to augment the ontology model with troponymes obtained from the lexical database.
